(19) United States
(12) Patent Application Publication
(10) Pub. No.: US 2026/0353096 A1
(43) Pub. Date: Nov. 5, 2026

(54) CONTEXTUAL ATTRIBUTE PROFILE BASED ACCESS TO WIRELESS NETWORKS

(71) Applicant: Microsoft Technology Licensing, LLC, Redmond, WA (US)

(72) Inventor: Ravi Kanth KAJA, Hyderabad (IN)

(21) Appl. No.: 19/199,147

(22) Filed: May 5, 2025

(51) Int. Cl. H04W 12/73; H04W 12/06; H04W 12/122; H04W 76/10

(52) U.S. Cl. CPC H04W 12/73; H04W 12/06; H04W 12/122; H04W 76/10

(57) ABSTRACT

Some cyber-attacks capitalize on the widespread use of public Wi-Fi hotspots, which are often found in coffee shops, airports, hotels, and other public places. In these attacks, cybercriminals set up rogue Wi-Fi networks that closely resemble legitimate ones. This deceptive tactic tricks unsuspecting users into connecting to the fraudulent network, believing it to be legitimate public Wi-Fi. Once connected, users may unknowingly expose themselves to various risks. Malicious actors can intercept data transmitted between the victim's computing device and a rogue Wi-Fi network. This interception can include sensitive information like login credentials, financial data, or personal communications. Furthermore, attackers can deploy various techniques to inject malware or malicious code into the victim's computing device. This application describes adaptive profiling secure access techniques that leverage contextual attributes of Wi-Fi access points to monitor, track, and detect anomalies to reduce or eliminate these attacks.

### BACKGROUND

This disclosure relates to securely accessing wireless networks.

A wireless network enables internet access, communication, or other operations by a computing device. It may be difficult to verify the identity associated with a given wireless network. For instance, if an establishment makes a wireless network available for use by computing devices of its patrons, it may be difficult to discern the wireless network of the establishment from a fraudulent wireless network that is configured to appear similar and thus trick unsuspecting users into using the fraudulent wireless network instead of the establishment's wireless network resolution.

### SUMMARY

Some cyber-attacks capitalize on the widespread use of public Wi-Fi hotspots, which are often found in coffee shops, airports, hotels, and other public places. In these attacks, cybercriminals set up rogue Wi-Fi networks that closely resemble legitimate ones, typically by using a similar name or SSID (Service Set Identifier). This deceptive tactic tricks unsuspecting users into connecting to the fraudulent network, believing it to be legitimate public Wi-Fi. Once connected, users may unknowingly expose themselves to various risks. Malicious actors can intercept data transmitted between the victim's computing device and a rogue Wi-Fi network. This interception can include sensitive information like login credentials, financial data, or personal communications. Furthermore, attackers can deploy various techniques to inject malware or malicious code into the victim's computing device. This application describes adaptive profiling secure access techniques that leverage contextual attributes of Wi-Fi access points to monitor, track, and detect anomalies to reduce or eliminate these attacks.

Some embodiments include a method for securely accessing a wireless network (e.g., a Wi-Fi network). The method comprises determining, with a computing device, one or more attributes of an access point to a wireless network. The one or more attributes provide context associated with the access point. The method comprises comparing, with the computing device, the one or more attributes of the access point to a stored profile associated with the access point and the computing device. The stored profile comprises previous values for the one or more attributes. The comparing ensures the context associated with the access point is consistent with the stored profile for the access point and the computing device. Responsive to the attributes of the access point being consistent with the stored profile for the access point, the method comprises establishing, with the computing device, a connection to the wireless network using the access point. “Consistent”, in the context of this disclosure, means that the attributes observed from the access point, when compared with the stored profile, are within an expected range or present expected qualities, for example.

The attributes comprise default attributes, and extended attributes. The default attributes comprise one or more of identifiers, authentication modalities, and communication specifications of the access point; including one or more of a service set identifier (SSID) or network name, a basic service set identifier (BSSID), an authentication mode, a frequency band, a channel width, a data transfer rate including one or both of a transmit rate or a receive rate, one or more characteristics of a processor utilized by the access point, an encryption protocol, one or more access point firmware characteristics, and one or more access point software characteristics. The extended attributes comprise one or more of a number of hops between the computing device and the access point, a geographical access point location, a triangulated position of the access point, a physical distance from the computing device to the access point, a re-authentication interval; computing device security protocol transition; uppercase media access control authentication; and a received signal strength indicator (RSSI). In some embodiments, at least some of the one or more attributes are determined based on others of the one or more attributes.

The access point comprises one or more of a router, a wireless network adapter, a Wi-Fi chipset, a hotspot, or other access points.

In some embodiments, the stored profile comprises a stored profile for an alternate access point at a same geographical access point location. In some embodiments, the stored profile is configured to be shared between the computing device and one or more other computing devices belonging to a user. In some embodiments, the stored profile is stored on one or more computing devices belonging to a user.

In some embodiments, the stored profile for the access point comprises an aggregate historical set of attributes for the access point. The previous values are determined based on the aggregate historical set of attributes.

In some embodiments, the method comprises updating, responsive to the one or more attributes being consistent with the stored profile, the stored profile with the computing device, based on the one or more attributes.

In some embodiments, the method comprises iteratively updating the stored profile each time the computing device attempts to connect to the wireless network using the access point, responsive to the one or more attributes being consistent with the stored profile for that connection attempt.

In some embodiments, the previous values for one or more of the attributes comprise an aggregate value associated with a combination of at least two of the attributes. In some embodiments, the previous values for one or more of the attributes comprise one or more per attribute values associated with individual attributes.

In some embodiments, the determining, comparing, and establishing is configured to prevent connection to a fraudulent wireless network.

In some embodiments, the method comprises, responsive to the one or more attributes of the access point not being consistent with the stored profile, not establishing the connection to the wireless network using the access point, and instead outputting, with the computing device, an indication that the access point might be fraudulent.

In some embodiments, the method comprises requiring a user intervention, for verification and re-connecting to the access point, to safely connect with the wireless network to ensure that the computing device is connecting to an authentic endpoint, and not a fraudulent wireless network.

In some embodiments, the computing device comprises a smartphone, laptop computer or other user-associated devices such as smart watches, fitness trackers, internet of things (IoT) devices, smart devices such as televisions, refrigerators, and other smart home devices, etc.

In some embodiments, the determining, comparing, and establishing are performed by the computing device, independent of access point hardware or access point configurations that are provided by the access point.

In some embodiments, the method comprises performing the determining, comparing, and establishing with the computing device each time the computing device attempts to connect to the wireless network using the access point.

Some embodiments include a tangible, non-transitory, machine-readable memory storing instructions that, when executed by a data processing apparatus such as a processor, cause the data processing apparatus to perform one or more described operations.

Some embodiments include a computing device comprising one or more processors, memory, or other components. The memory stores instructions that, when executed by the one or more processors, effectuate one or more described operations.

### BRIEF DESCRIPTION OF THE DRAWINGS

The above-mentioned aspects and other aspects of the present techniques will be better understood when the present application is read in view of the following figures in which like numbers indicate similar or identical elements.

FIG. 1 illustrates a system for securely accessing a wireless network.

FIG. 2 illustrates safely connecting with the wireless network to ensure that a computing device is connected to an authentic endpoint, and not a fraudulent wireless network.

FIG. 3 illustrates an example flow of operations performed by the system and described as part of FIG. 1.

FIG. 4 illustrates different example embodiments of a method for securely accessing a wireless network.

FIG. 5 illustrates an example computing device.

### DETAILED DESCRIPTION OF CERTAIN EMBODIMENTS

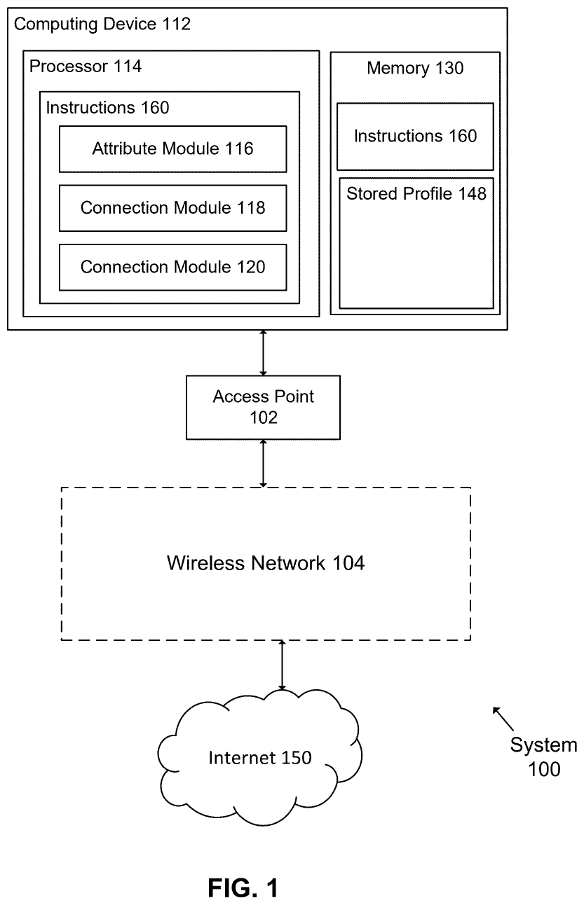

FIG. 1 illustrates a system 100 comprising a computing device 112 and other components configured for securely accessing a wireless network. Securely accessing a wireless network involves verifying that a user connects to a legitimate and trusted access point rather than an unauthorized or fraudulent network. This process typically includes authentication mechanisms such as verifying the network's service set identifier (SSID), or using security protocols like WPA2 or WPA3, for example. By ensuring a reliable and authenticated connection, users can protect their data from interception, unauthorized access, and other security threats posed by attackers attempting to impersonate trusted networks.

Fraudulent network attacks (sometimes referred to as “evil-twin” attacks) are a form of cyber threat that capitalizes on the widespread use of public wireless networks (e.g., Wi-Fi hotspots), which are often found in coffee shops, airports, hotels, and other public places. In these attacks, cybercriminals set up fraudulent wireless networks that closely resemble legitimate ones, typically by using a similar name or SSID. This deceptive tactic tricks unsuspecting users into connecting to the fraudulent network, believing it to be a legitimate public wireless network. Once connected, users may unknowingly expose themselves to various risks. Malicious actors can intercept data transmitted between the user's computing device 112 (e.g., smartphone, laptop computer, smartwatch, tablet, etc.) and the fraudulent wireless network. This interception can include sensitive information like login credentials, financial data, or personal communications. Furthermore, attackers can deploy various techniques to inject malware or malicious code into the user's computing device.

For example, an attacker can direct a user to a spoofed login page, leading to the exposure of the network login credentials. As another example, when users unknowingly connect to a fraudulent wireless network, cybercriminals can intercept sensitive data transmitted over the network like—login credentials, personal information, financial data etc. Sometimes, once a user is connected to a fraudulent network, an attacker can launch a “Man-in-the-Middle” attack. The attacker can intercept and monitor the traffic passing between the user's device and the internet. This gives the attacker the ability to steal sensitive data or manipulate the traffic. Attackers can also use such attacks as a gateway to distribute malware or ransomware to connected devices.

Advantageously, system 100 provides a client (e.g., a “client-side”) computing device (e.g., sometimes call a “station”) solution, which runs independently of any access point hardware or configurations. An access point is a networking device that allows wireless computing devices to connect to a wireless network (e.g., using Wi-Fi). An access point acts as a bridge between wireless clients (e.g., computing devices such as smartphones, laptops, smartwatches, tablets, etc.) and the wireless network. A user's computing device 112 (or a set of one or more computing devices 112 associated with the user collectively—e.g., one or more of the user's laptop, smartphone, and smartwatch) maintains a stored profile for an access point that is regularly updated so that, when computing device 112 identifies an access point for connecting to a wireless network, attributes of the stored profile can be evaluated against previous values for those attributes to determine whether the access point and its associated wireless network are authentic. User intervention, verification, and re-authentication may be required to safely connect with the access point if anomalies are detected.

System 100 provides technical solutions to technical problems related to securely accessing wireless networks. As described in greater detail below, system 100 provides a new structure (e.g., client side storage of extended access point attribute profiles) that provides secure access to wireless networks.

This is advantageous for several reasons. For example, large companies may rely on their global remote workforce connecting their computing devices to public (e.g., to work from a local coffee shop) and private networks (e.g., a home network). While company networks are typically secure, company computing devices may be exposed on other public or private networks which do not have the same level of security. Providing a universal security solution for company computing devices is difficult, because such solutions are usually access point hardware or configuration dependent. Access point hardware and configurations may be very different for different access points used by the company workforce (e.g., a coffee shop access point versus a home access point; an access point in the United States verses an access point in another country; etc.).

More details related to the technical solution(s) provided by system 100 are described below, after introducing the components of system 100 and describing their operation. It should be noted, however, that not all embodiments necessarily provide all of the benefits outlined herein, and some embodiments provide all or a subset of these benefits or different benefits, as various engineering and cost tradeoffs are envisioned, which is not to imply that other descriptions are limiting.

System 100 includes computing device 112, which may interact with an access point 102, a wireless network 104, a network 150 such as the internet, and/or other components. In some embodiments access point 102 and wireless network 104 may be associated with an establishment (e.g., a coffee shop, an airport, a school, or any other provider of a public wireless network). While system 100 is illustrated as including a single access point, and one wireless network 104, it will be appreciated that any number of such elements may be included in other examples. For example, one or more access points may be associated with one or more wireless networks.

As described above, access point 102 may be a networking device that allows wireless computing device(s) 112 to connect to wireless network 104. An access point acts as a bridge between wireless clients (e.g., computing device(s) 112 such as smartphones, laptops, tablets, Internet of Things (IoT) devices, edge devices, smart electronics (e.g., refrigerators, televisions, etc.), or other devices. etc.)) and wireless network 104. In some embodiments, access point 102 may comprise one or more of a router, a wireless network adapter, a Wi-Fi chipset, a switch, a port, a cable, a processor, memory, an antennae, a power supply, a hotspot, or other components.

Wireless network 104 is a communication network that enables computing devices 112 to exchange data or other information without physical connections, utilizing wireless signals for transmission. Wireless network 104 comprises or is associated with at least one access point 102 (e.g., a wireless router, as one possibility) which acts as a central hub, facilitating communication between connected devices such as smartphones, laptops, tablets, Internet of Things (IoT) devices, edge devices, smart electronics (e.g., refrigerators, televisions, etc.), or other devices. Wireless network 104 may operate on a standardized protocol, such as IEEE 802.11 (Wi-Fi), and may employ encryption and authentication mechanisms, including WPA2 or WPA3, to ensure secure data transmission. It will be appreciated that any of a variety of additional or alternative wireless network technologies (e.g., Bluetooth or a cellular network) may similarly be used in other examples. Network 150 comprises a network such as the Internet or the Internet in combination with various other networks, like local area networks, cellular networks, Wi-Fi networks, or personal area networks.

In some embodiments, computing device 112 includes one or more of a processor 114, a memory 130, or other components. These components, in some embodiments, communicate with one another in order to provide the functionality of computing device 112 described herein. In some embodiments, processor 114 in combination with instructions 160 stored in memory 130, or other components of computing device 112 (e.g., a network interface card (NIC)) comprise or function as a wireless connection manager. In some embodiments, the wireless connection manager scans for available wireless networks (e.g., one or more wireless networks 104). Scanning for an available wireless network 104 comprises detecting nearby access points 102 to determine which networks are available for connection. This involves listening for wireless signals (e.g., listening for beacon frames comprising SSID, signal strength, channel information, etc.) or actively probing for networks within range (e.g. broadcasting a probe request looking for nearby networks).

Computing device 112 may comprise a laptop, a smart phone, a tablet, a gaming device, an Internet of Things (IoT) device, an edge device, smart electronics (e.g., refrigerators, televisions, etc.), or other portable (or non-portable in some embodiments) networked computing devices. In some embodiments, computing device 112 shown in FIG. 1 is representative of a set of user computing devices 112, for example a set of one or more computing devices 112 collectively associated with a user collectively—one or more of the user's laptop, smartphone, smartwatch, etc. In some embodiments, computing device 112 is an individual computing device from such a set.

These devices may have one or more of a display, a user input device (e.g., buttons, keys, voice recognition, or a single or multi-touch touchscreen), memory 130 (such as a tangible, machine-readable, non-transitory memory), a network interface, a portable energy source (e.g., a battery), and a processor 114 (a term which, as used herein, includes one or more processors) coupled to these components. Memory 130 stores instructions 160 that when executed by the associated processor 114 provide an operating system and various applications, including a web browser, a native mobile application, or both.

A native application, or a web browser, in some embodiments, are operative to provide a graphical user interface, for example, which communicates with computing device 112 and facilitates user interaction with data from computing device 112. In some embodiments, computing device 112 is run as an application (e.g., an app such as native application) on a user computer, or other devices. In the context of system 100, a user may be a person who attempts to access a wireless network with computing device 112, for example.

Memory 130 stores instructions 160 that, when executed by processor 114, cause processor 114 to execute the various operations described herein. In some embodiments, memory 130 stores (e.g., attributes or a stored profile 148 as described herein) or is configured to access other data, or other information that otherwise allows system 100 to function as described herein. In some embodiments, memory 130 includes various types of data stores, including relational or non-relational databases; image, document, etc., collections; or programming instructions for example. In some embodiments, such components are formed in a single database, or are stored in separate data structures. In some embodiments, memory 130 comprises electronic storage media that electronically stores information. In some embodiments, the electronic storage media of memory 130 includes one or both of system storage that is provided integrally (i.e., substantially non-removable) with system 100 or other storage that is connectable (wirelessly or via a wired connection) to system 100 via, for example, a port, a drive, a network (e.g., the Internet), etc. In some embodiments, memory 130 is (in whole or in part) a separate component within system 100, or memory 130 is provided (in whole or in part) integrally with one or more other components of system 100 (e.g., processor 114). In some embodiments, one or more portions of memory 130 are located in different computing devices 112 associated with a user, or in other locations. In some embodiments, memory 130 includes one or more of optically readable storage media, magnetically readable storage media, electrical charge-based storage media (e.g., EPROM, RAM, etc.), solid-state storage media, or other electronically readable storage media. In some embodiments, memory 130 stores software algorithms, information determined by processor 114, information received via a graphical user interface, information received from external resources (e.g., data from a search of a relevant database), or other information accessed by system 100 to function as described herein.

Processor 114 is configured to coordinate the operation of the other components of computing device 112 to provide the functionality described herein. In some embodiments, processor 114 is formed by two or more processors, for example.

As shown in FIG. 1, in some embodiments, instructions 160 comprise an attribute module 116, a comparison module 118, and a connection module 120. Processor 114 is configured to direct the operation of modules 116, 118, or 120 by software; hardware; firmware; some combination of software, hardware, or firmware; machine-readable instructions; or other mechanisms for configuring processing capabilities.

Attribute module 116 is configured to determine one or more attributes of access point 102 for wireless network 104. Attribute module 116 may interact directly with access point 102 to provide this functionality. The one or more attributes provide context associated with the access point. Context refers to the surrounding information or circumstances that give additional meaning to the attributes and other information obtained from access point 102. Context helps attribute module 116 to determine the attributes, understand how to interpret an attribute, or perform other operations. Context can be derived from an attribute, a combination of attributes, background information already known about access point 102, a logical or temporal relationship between attributes, etc. In some embodiments, context comprises any information that enhances determination or understanding of an attribute. In some embodiments, determining the one or more attributes of access point 102 for wireless network 104 comprises active or passive scanning. For example, attribute module 116 may be configured such that attributes are determined based on beacon frames, probe requests/responses, association processes, or other operations.

Attributes of access point 102 for wireless network 104 comprise characteristics or elements of access point 102 or wireless network 104. In some embodiments, the attributes comprise default attributes, and extended attributes. Default attributes comprise attributes that access points are configured with, and extended attributes comprise attributes that the computing device 112 can determine with and associate with access point 102, which are contextual in nature.

Default attributes may comprise one or more of identifiers, authentication modalities, communication specifications of the access point, or other attributes. These may include one or more of a service set identifier (SSID) or network name, a basic service set identifier (BSSID), an authentication mode, a frequency band, a channel width, a data transfer rate including one or both of a transmit rate or a receive rate, one or more characteristics of a processor utilized by the access point, an encryption protocol, one or more access point firmware characteristics, one or more access point software characteristics, or other attributes, for example. Note that such attributes can vary based on the access point configurations provided by manufacturers or software providers for the access points, or other factors. Further, there may be additional attributes associated with the nature of authentication. For example, if a computing device 112 establishes a pre-shared key (PSK) based authentication (Example: wpa-psk or wpa2-psk) with an access point, a specific attribute related to this authentication type, the PSK, will be stored on the computing device. This attribute, essentially the password to the wireless network, will be used for future connections to the wireless network.

In some embodiments, the extended attributes comprise one or more of a number of hops between the computing device and the access point, a geographical access point location, a triangulated position of the access point, a physical distance from the computing device to the access point, a re-authentication interval, a computing device security protocol transition, uppercase media access control authentication, a received signal strength indicator (RSSI), or other attributes. In some embodiments, at least some of the one or more (extended) attributes are determined based on others of the one or more attributes. For example, an attribute may comprise a triangulated position of access point 102—i.e., where in the physical space at an establishment access point 102 is located. This triangulated position can be determined based on signal strength (e.g., another attribute) and other Wi-Fi positioning techniques.

In some embodiments, extended attributes may be determined based on observations, trial and error methods, or other techniques. Several examples follow. Re-authentication Interval: if enabled by an access point, attribute module 116 can be configured to monitor a gap between consistent and repetitive re-authentication requests enforced by the access point and maintain this as a characteristic or configuration attribute of the access point. WPA3 Transition: some characteristics, like WPA3 Transition, can be accessed from Wi-Fi frames and stored as part of WLAN profile attributes. Alternatively, for a non-enterprise access point, by attempting to connect to an access point with both WPA2-Personal and WPA3-Personal, the attribute module 116 can identify whether a WPA3 Transition is enforced (e.g., another example attribute). Uppercase Support: for an access point from a certain manufacturer with MAC authentication enabled, this configuration can be verified by attribute module 116 by testing with an uppercase-MAC address while establishing a connection with the access point. Note that these are just examples used to provide insights into what is possible. Other examples are contemplated.

Comparison Module 118 is configured to compare the one or more attributes of access point 102 to a stored profile 148 associated with access point 102 and computing device 112. The stored profile 148 comprises previous values for the one or more attributes, or other information. The comparing ensures the context associated with access point 102 is consistent with the stored profile 148 for access point 102 and computing device 112. As described above, “consistent”, in the context of this disclosure, means that the attributes observed from the access point, when compared with the stored profile, are within an expected range or present expected qualities, for example. Comparison module 118 is configured to make comparisons across any number of attributes. These comparisons may be performed based on textual analyses (e.g., for network name recognition) or numerical analyses, performed using mathematical metrics, may be based on acceptable ranges, may more generally quantify how alike or different one or more attributes are from what is expected based on a stored profile, may be based on physical proximity determinations, or intellectual evaluations that assess the validity of detected attributes against known information, ensuring consistency and accuracy in the context of the expected environment (for example, a WiFi network named coffeeshop-ABC” should only appear at locations where there is known information from the internet or other peer-devices about a ‘coffeeshop-ABC’ outlet. If it appears at a different location without such information, it may be considered incorrect), or be based on other factors. In some embodiments, the stored profile 148 comprises one or more (previous value) thresholds for the one or more attributes, or other information. Comparisons may be made between attributes and thresholds for those attributes, for example.

Stored profiles 148 may be stored in any data sources available to system 100 for searching or otherwise using to function as described. This may include memory 130 in any one of a user's computing devices 112. In some embodiments, a stored profile 148 is configured to be shared between computing device 112 and one or more other computing devices 112 belonging to a user. A stored profile 148 may be associated with access point 102 and computing device 112 and/or one or more computing devices 112 in a set of computing devices associated with a user. A stored profile 148 may be shared between the one or more computing devices 112 in the set. Phrased another way, a stored profile 148 may be stored on one or more of computing device 112 and one or more additional computing devices 112 belonging to a user.

For example, stored profiles 148 (or portions thereof—e.g., individual attributes) may be stored in different ones of a user's computing devices 112—a user's laptop, a user's smartphone, etc. Stored profiles 148 may be shared between these devices. Stored profiles 148 may comprise a large and varied set of data, with many different types of data, access protocols, etc. In some embodiments, stored profiles 148 comprise tabular data, graph data, data tables, columns of data, documents, charts, images, video, sensor data, or other data. Even though only one stored profile 148 is shown in FIG. 1, this is intended to represent any number of different available stored profiles 148. In some embodiments, some or all of the different available stored profiles 148 are co-located (e.g., in memory 130 in computing device 112), or individual available stored profiles 148 are located remotely (e.g., other computing devices 112 associated with a user) from other stored profiles 148.

Computing devices 112 such as laptops, smartphones, smartwatches, and tablets can communicate with each other using various wireless and wired technologies. These communication methods allow data sharing, synchronization, and remote control between devices owned by the same user. Such techniques may include AirDrop (Apple), Nearby Share (Android), SMB file sharing, Bluetooth communication, near field communication (NFC), cellular network based communication, wired (e.g., USB, HDMI, Ethernet, etc.) connections, or other techniques.

By way of a practical example, for access point 102, authentication attributes can be associated with two different authentication modes—WPA3-Personal and WPA2-Personal, based on the most secure authentication mechanism that a computing device 112 can support. Physical address related MAC values can change over time if a computing device 112 is enforced to rotate them for any reason, whether manual or automated. As such, if a stored profile 148, or attributes associated with the stored profile 148, are shared across computing devices 112, such conditions are considered when evaluating thresholds (as described herein). For example, if a laptop has WPA3-Personal authentication and a smartphone finds that the best match WLAN profile it has is WPA2-Personal, it could simply mean that the mobile device can only support WPA2-Personal. This does not necessarily indicate any anomaly.

In some embodiments, stored profile 148 for access point 102 comprises an aggregate historical set of attributes for access point 102. An aggregate historical set of attributes for access point 102 comprises a compiled dataset that records and updates access point 102 attributes over time. This dataset helps determine previous values and/or associated thresholds based on trends, performance, security, stability, or other characteristics of wireless network 104 over time. The previous values and/or one or more thresholds may be determined based on the aggregate historical set of attributes, for example. Comparison module 118 may determine the one or more thresholds based on the previous values or other information. For example, thresholds may be determined using statistical analyses such as moving averages, standard deviations, or percentile-based benchmarks derived based on the previous values. Alternatively, thresholds may be determined based on machine learning models trained to identify normal and anomalous behavior patterns specific to the previous values for access point 102 within wireless network 104.

In some embodiments, a stored profile 148 comprises a stored profile 148 for an alternate access point (e.g., an access point other than access point 102) at a same geographical access point location (e.g., for another wireless network provided by an establishment—such as a coffee shop or airport, etc., that provides two or more different wireless networks for its customers). These networks may serve different purposes, such as offering separate public and private Wi-Fi access, distinct networks for different service tiers (e.g., free versus premium access), or networks optimized for specific user groups (e.g., guest networks versus employee-only networks). A stored profile 148 for an alternate access point may still enable computing device 112 to recognize and connect to access point 102 based on the previous values and/or one or more predefined thresholds determined based on the previous values for the attributes described herein. For example, comparison module 118 may recognize similarities between attributes (e.g., location, signal strength, etc.) of the different access points, and conclude (e.g., based on one or more previous values and/or associated thresholds) that access via access point 102 would be secure, even though the stored profile 148 was for an alternate access point. In an example scenario like this, if computing device 112 has a stored WLAN profile for ‘coffeeshop-ABC’ and attempts to connect to a new SSID ‘coffeeshop-XYZ’ (provided by the same coffee shop), comparison module 118 can leverage the stored profile 148 from the ‘coffeeshop-ABC’ profile to evaluate or identify any anomalies with ‘coffeeshop-XYZ’. As another example, there may be a stored profile for ‘coffeeshop-ABC’ at a GPS location (call (a,b)) which matches with that of a reputed coffeeshop chain. If there is a new WiFi Access point at a new GPC location (call(x,y)), and the computing device has information that this location also belongs to the same said coffeeshop chain, the computing device can still use the stored profile of ‘coffeeshop-ABC’ as there is an established/expected correlation here.

Previous values for attributes, or an associated threshold can broadly encompass a single value (e.g., a network name, or a number of hops), a range of values (e.g., a range of acceptable signal strengths), an aggregate of several attributes, etc. In some embodiments, the previous values for one or more of the attributes comprise an aggregate value associated with a combination of at least two of the attributes. This aggregate value may be used to evaluate whether access point 102 and wireless network 104 are authentic based on multiple attributes, such as one or more of the attributes described herein. By combining these attributes into a single previous value, comparison module 118 can make intelligent decisions regarding wireless network 104 access. Similarly, in some embodiments, one or more thresholds for one or more of the attributes may comprise an aggregate threshold associated with a combination of at least two of the attributes. This aggregate threshold may be used to evaluate whether access point 102 and wireless network 104 are authentic based on multiple attributes, such as one or more of the attributes described herein. By combining these attributes into a single threshold, comparison module 118 can make intelligent decisions regarding wireless network 104 access. For example, access point 102 and wireless network 104 may be deemed secure if a combined threshold of both a recognized signal strength (e.g., −65 dBm) and a recognized data rate (e.g., 20 Mbps) are determined, even if an individual attribute alone would not meet a standalone criterion.

In some embodiments, previous values or the one or more thresholds for one or more of the attributes comprise one or more per-attribute values or thresholds associated with individual attributes. This means that one or more individual attributes may be evaluated independently against their respective previous value or threshold to determine wireless network suitability. For example, separate values or thresholds may be set for signal strength, or authentication security (as just two possible examples of many attributes described herein), allowing comparison module 118 to reject wireless network 104 if any one of these attributes is not consistent with a previous value, or does not satisfy a corresponding threshold. Such an approach may provide more granular control over wireless network selection, ensuring that certain attributes like security protocols (e.g., WPA3 vs. WPA2) or PSK (if applicable) are enforced independently of other thresholds for other attributes, among other advantages.

In some embodiments, a hybrid approach may be utilized, where both aggregate and per-attribute values or thresholds are employed. This enables a more flexible and adaptive decision-making process, where certain value consistency or threshold requirements for one or more individual attributes must be met, but an overall stored profile 148 can also be considered more holistically.

Previous values or thresholds can also extend beyond individual or aggregated attribute values or thresholds. Values or thresholds can also be algorithmic in nature and involve additional considerations, such as the following examples. Nature of Specific Attributes: different attributes can have varying levels of importance or weight. For example, deviations in ‘transmit rate’ or ‘receive rate’ might be given lesser importance compared to deviations in ‘physical address’ or ‘network adapter details’. Interaction of Adjacent Attribute Values: the values of adjacent attributes falling within or outside the range can influence the threshold of the attribute being considered. For example, if ‘attribute1’ exceeds ‘threshold1’ and ‘attribute2’ is below ‘threshold2’, comparison module 118 might ignore the fact that ‘attribute3’ exceeds ‘threshold3’. Contextual Information from computing device 112/access point 102: additional context derived from computing device 112 or access point 102 can be leveraged in evaluating previous values or determining thresholds to detect anomalies. For example, if computing device 112 regularly connects to access point 102 at a coffee shop with the SSID ‘coffeeshop-ABC’ in zip code 100000, and later connects to a similar SSID ‘coffeeshop-XYZ’ in zip code 200000, comparison module 118 can evaluate whether there is a coffee shop at zip code 200000. This logic can be similarly applied to other locations such as universities, schools, airports, and libraries, etc.

Connection module 120 is configured, responsive to the attributes of access point 102 being consistent with the stored profile for access point 102 (e.g., the attributes are consistent with the previous values for those attributes), or satisfying the one or more thresholds associated with stored profile 148 for access point 102, establish a connection to wireless network 104 using access point 102. Connection module 120 is also configured, again responsive to the one or more attributes being consistent with the stored profile for access point 102 or satisfying the one or more thresholds of stored profile 148, to update stored profile 148 based on the one or more attributes. Connection module 120 may be configured to iteratively update stored profile 148 each time computing device 112 attempts to connect to wireless network 104 using access point 102, responsive to the one or more attributes being consistent with the stored profile for access point 102 or satisfying the one or more thresholds of stored profile 148 for that connection attempt.

Responsive to the one or more attributes of access point 102 not being consistent with the stored profile for access point 102, or not satisfying the one or more thresholds, connection module 120 does not establish the connection to wireless network 104 using access point 102. Instead, connection module 120 is configured to output (e.g., with a graphical user interface or other output mechanism associated with computing device 112 as described herein), an indication that access point 102 might be fraudulent. Connection module 120 may require a user intervention for verification and re-connecting to access point 102, to safely connect with wireless network 104 to ensure that computing device 112 is connecting to an authentic endpoint, and not a fraudulent wireless network. For example, a user may receive an alert: “Network ‘CoffeeShopWiFi’ may be spoofed. Connect anyway?” Other examples of these user interventions include reentering or reconfirming credentials such as network passwords, relogging into a network specific portal, manually selecting an access point, confirming a connection to an access point, confirming trust in a new certificate, manually forgetting and reconnecting to a wireless network, manually accepting terms for reconnection, approving a connection on a different computing device, etc.

The attribute determination by attribute module 116, the comparing by comparison module 118, and the establishing of the connection by connection module 120 may be configured to be performed each time computing device 112 attempts to connect to wireless network 104 using access point 102. The attribute determination by attribute module 116, the comparing by comparison module 118, and the establishing of the connection by connection module 120 is configured to prevent connection to a fraudulent wireless network. This determining, comparing, and establishing are performed by computing device 112 (e.g., modules 116-120), beyond the use of configurations provided by the access point, and independently of access point 102 hardware or access point 102 configurations that are provided by access point 102 (thus making this a “client side” solution, with its associated advantages, as described above). The determining, comparing, and establishing are performed by computing device 112, independent of access point hardware or access point configurations that are readily provided by the access point. As described above, computing device 112 can determine attributes and maintain profiles with (i) contextual attributes like geo-location, triangulated location patterns of a user's proximity and angle towards the access point, etc.; (ii) other attributes specific to the access point hardware or configurations—that are formulated by observation or determination (and not necessarily provided by the access point to computing device 112).

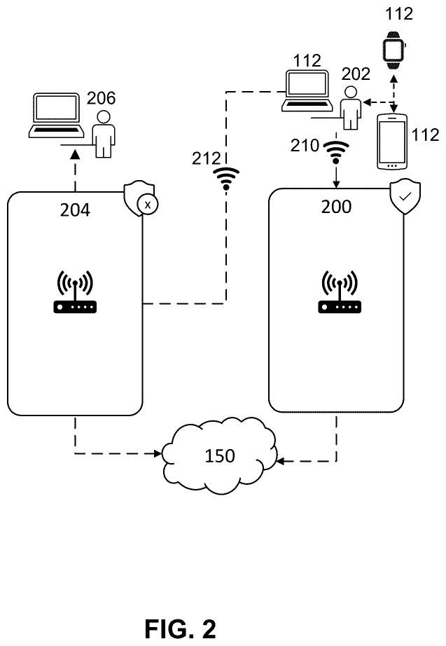

Several additional details related to the operations performed by modules 116-120 are illustrated in FIGS. 2-5, and described below.

For example, FIG. 2 illustrates safely connecting with a legitimate wireless network 200, and ensuring that a computing device 112 (e.g., a laptop, a smartphone, or a smartwatch in this example) associated with a user 202 is connected to an authentic endpoint, and not a fraudulent wireless network 204 from an attacker 206. A computing device 112 (e.g., attribute module 116 shown in FIG. 1) is configured to determine one or more attributes of an access point 210 (similar to or the same as access point 102 described above and shown in FIG. 1) to wireless network 200 (similar to or the same as wireless network 104 described above and shown in FIG. 1). As described above, the one or more attributes provide context associated with access point 210. The computing device 112 (e.g., comparison module 118 shown in FIG. 1) is configured to compare the one or more attributes of access point 210 to a stored profile associated with access point 210 and the computing device 112. The stored profile comprises previous values or one or more thresholds for the one or more attributes. The comparing ensures the context associated with access point 210 is consistent with the stored profile for access point 210 and the computing device 112. Responsive to the attributes of access point 210 being consistent with the stored profile for access point 210, or satisfying the one or more thresholds associated with the stored profile for access point 210, the computing device 112 (e.g., connection module 120 shown in FIG. 1) is configured to establish a connection to wireless network 200 using access point 210.

In this example, attacker 206 is attempting a fraudulent wireless network 204 attack (sometimes referred to as an “evil-twin” attack) which capitalizes on the widespread use of public wireless networks (e.g., Wi-Fi hotspots), often found in coffee shops, airports, hotels, and other public places. In this attack, attacker 206 set up fraudulent wireless network 204 to closely resemble wireless network 200. Fraudulent wireless network 204 may be accessed via access point 212, which may have a similar name or SSID to that of access point 210, for example. This deceptive tactic might have tricked user 202 into connecting to fraudulent wireless network 204, believing it to be legitimate public wireless network 200, if not for the functionality provided by computing device 112 described herein.

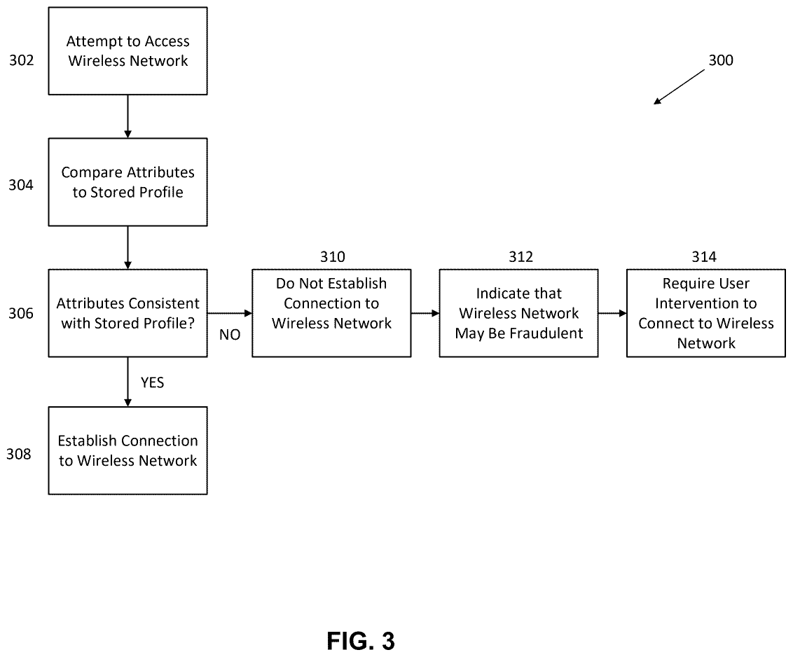

FIG. 3 illustrates an example flow 300 of some of example operations performed by system 100 (FIG. 1) described above. FIG. 3 provides an alternative visual illustration of some of the operations described with respect to FIG. 1 and FIG. 2. Flow 300 begins with operation 302, comprising a computing device attempting to connect to a wireless network. At operation 304, attributes of an access point to the wireless network are compared to a stored profile (e.g., as described above). Operation 306 comprises determining whether the attributes are consistent with the stored profile for the access point, or satisfy one or more thresholds of the stored profile. If they are (e.g., “yes” at operation 306), a connection to the wireless network is established. If not (e.g., “no” at operation 306), a connection to the wireless network is not established (operation 310), and an indication that the wireless network may be fraudulent is output to the user (operation 312). The user may then be required to intervene to connect to the wireless network if a connection is still desired (operation 314).

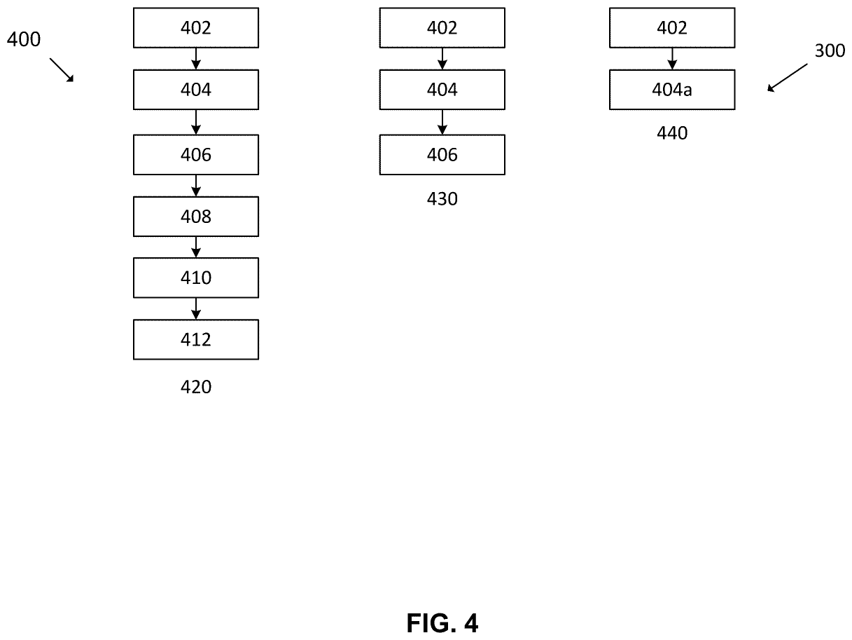

FIG. 4 illustrates different example embodiments 420, 430, and 440 of a method 400 for securely accessing a wireless network. Embodiments 420, 430, and 440 of method 400 are performed with system 100, computing device 112, or other components discussed herein. Embodiments 420, 430, or 440 may correspond to one or more of the pathways through the flow shown in FIG. 3, for example.

Embodiment 420 of method 400 begins with operation 402, determining, with a computing device, one or more attributes of an access point to a wireless network. The one or more attributes provide context associated with the access point. Embodiment 420 continues with operation 404, comprising comparing, with the computing device, the one or more attributes of the access point to a stored profile associated with the access point and the computing device. The stored profile comprises previous values of, and/or one or more thresholds for, the one or more attributes. The comparing ensures the context associated with the access point is consistent with the stored profile for the access point and the computing device. Operation 406 comprises, responsive to the attributes of the access point being consistent with the stored profile, and/or satisfying the one or more thresholds associated with the stored profile for the access point, establishing, with the computing device, a connection to the wireless network using the access point. Operation 408 comprises updating the stored profile with the computing device, based on the one or more attributes or other information. Operation 410 comprises, responsive to the one or more attributes of the access point not being consistent with the stored profile, and/or not satisfying the one or more thresholds, not establishing the connection to the wireless network using the access point. Instead, the computing device is configured to output an indication that the access point might be fraudulent; and require a user intervention, for verification and re-connecting to the access point, to safely connect with the wireless network to ensure that the computing device is connecting to an authentic endpoint, and not a fraudulent wireless network. Operation 412 comprises performing the determining, comparing, and establishing or not establishing with the computing device each time the computing device attempts to connect to the wireless network using the access point (e.g., all as described above).

Embodiment 430 of method 400 begins with operation 402, again comprising determining, with the computing device, the one or more attributes of the access point to the wireless network. Embodiment 430 continues with operation 404, comprising comparing, with the computing device, the one or more attributes of the access point to the stored profile associated with the access point and the computing device. Embodiment 430 finishes with operation 406 comprising, responsive to the attributes of the access point being consistent with the stored profile, and/or satisfying the one or more thresholds associated with the stored profile for the access point, establishing, with the computing device, the connection to the wireless network using the access point.

Embodiment 440 of method 400 also begins with operation 402, again comprising determining, with the computing device, the one or more attributes of the access point to the wireless network. Embodiment 440 concludes with operation 404a, comprising comparing the one or more attributes of the access point to the stored profile associated with the access point and the computing device, and/or one or more of computing devices in a set. The stored profile is shared between the one or more computing devices in the set. The stored profile again comprises previous values, and/or one or more thresholds, for the one or more attributes, and the comparing ensures the context associated with the access point is consistent with the stored profile for the access point and the one or more computing devices.

Embodiments 420, 430, and 440 of method 400 may include additional operations that are not described, or do not include one or more of the operations described below. The operations of embodiments 420, 430, and 440 of method 400 may be performed in any order that facilitates securely accessing a wireless network, as described herein. Even though these are shown as separate embodiments, operations from one embodiment may be combined with another. In addition, embodiments 420, 430, and 440 are not the only three possible embodiments of method 400. Other variations are contemplated.

Returning to FIG. 1, system 100 can have many different forms, with or without some or all of the components shown in FIG. 1, and still be configured to function as described. One or more components of system 100 may communicate with devices outside system 100 via network 150, via other types of wireless connections, via wired connections, or using other techniques. The illustrated components of system 100 communicate directly with each other (e.g., via network 150 or a wired connection), or indirectly via other components of system 100.

It should be noted that in some embodiments, one or more instances of computing device 112 may be configured such that in the above mentioned operations of processor 114, input from users or sources of information inside or outside system 100, are processed by processor 114 through a variety of formats, including clicks, touches, uploads, downloads, etc. The illustrated components of computing device 112 are depicted as discrete functional blocks, but embodiments are not limited to systems in which the functionality described herein is organized as illustrated by FIG. 1. In some embodiments, the functionality provided by the components of computing device 112 or processor 114 is provided by software or hardware modules that are differently organized than is presently depicted, for example such software or hardware is intermingled, broken up, distributed (e.g., within a data center or geographically), or otherwise differently organized. In some embodiments, the functionality described is provided by one or more processors of one or more computers executing code stored on a tangible, non-transitory, machine readable medium.

Although modules 116-120 are illustrated in FIG. 1 as being co-located, one or more of modules 116, 118, or 120 may be located remotely from the other modules. The description of the functionality provided by the different modules 116-120 described herein is for illustrative purposes, and is not intended to be limiting, as any of the modules 116-120 may provide more or less functionality than is described, which is not to imply that other descriptions are limiting. For example, one or more of modules 116, 118, or 120 may be eliminated, and some or all of its functionality may be provided by others of the modules 116-120, again which is not to imply that other descriptions are limiting. As another example, processor 114 may be configured to control one or more additional modules that perform some or all of the functionality attributed to one of the modules 116-120.

Modules 116-120 are program instructions that are executable by a processor 114 to implement one or more embodiments of the present techniques. In some embodiments, program instructions include a computer program (which in certain forms is known as a program, software, software application, script, or code). A computer program is written in a programming language, including compiled or interpreted languages, or declarative or procedural languages. In some embodiments, a computer program includes a unit suitable for use in a computing environment, including as a stand-alone program, a module, a component, or a subroutine. In some embodiments, a computer program corresponds to a file in a file system. A program is stored in a portion of a file that holds other programs or data (e.g., one or more scripts stored in a markup language document), in a single file dedicated to the program in question, or in multiple coordinated files (e.g., files that store one or more modules, sub programs, or portions of code). In some embodiments, a computer program is deployed to be executed on one or more computer processors located locally at one site or distributed across multiple remote sites and interconnected by a communication network, for example.

In FIG. 1, one computing device 112 is shown, but embodiments are expected to include substantially more, with more than 100 concurrent user devices 112 and serving more than 1 million users distributed over a relatively large geographic area, such as a state, the entire United States, or multiple countries across the world.

Though not illustrated in FIG. 1, computing device 112, in some embodiments, includes multiple processors 114, an input/output I/O device interface, and a network interface via an input/output (I/O) interface. In some embodiments, multiple processors are employed to provide for parallel or sequential execution of one or more portions of the techniques described herein. The I/O device interface provides an interface for connection of one or more I/O devices to computing device 112. I/O devices include devices that receive input (e.g., from a user) or output information (e.g., to a user). I/O devices include, for example, graphical user interfaces presented on displays (e.g., a touchscreen or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices are connected to computing engine through a wired or wireless connection. I/O devices are connected to computing device 112 from a remote location. I/O devices located on a remote computer system, for example, are connected to computing device 112 via network 104 and/or network 150 and the network interface.

The network interface includes a network adapter that provides for connection of computing device 112 to network 104 and/or network 150. The network interface facilitates data exchange between computing device 112 and other devices connected to network 104 and/or network 150. The network interface supports wired or wireless communication. In some embodiments, network 150 includes an electronic communication network, such as the Internet, a local area network (LAN), a wide area network (WAN), a cellular communications network, and the like.

The I/O interface is configured to coordinate I/O traffic between processors, memory 130, the network interface, I/O devices, or other peripheral devices. The I/O interface performs protocol, timing, or other data transformations to convert data signals from one component (e.g., memory 130) into a format suitable for use by another component (e.g., processor(s) 114). In some embodiments, the I/O interface includes support for devices attached through various types of peripheral buses, such as a variant of the Peripheral Component Interconnect (PCI) bus standard or the Universal Serial Bus (USB or USB-C) standard.

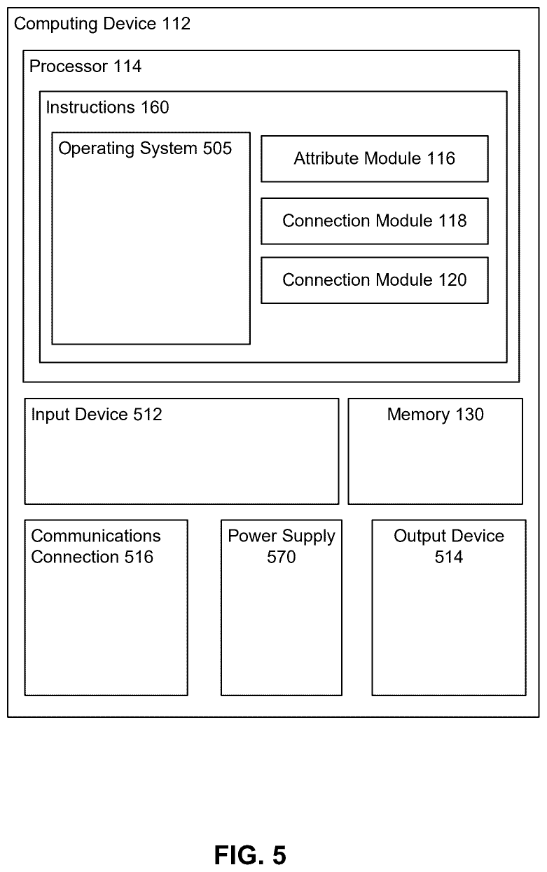

FIG. 5 illustrates an example of a computing device 112. FIG. 5 and the associated description provides a discussion of a variety of operating environments in which aspects of the disclosure may be practiced. However, the devices and systems illustrated and discussed with respect to FIG. 5 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 112 with which aspects of the disclosure may be practiced. Computing device 112 is representative of one or more of a laptop computer, a smartphone, a smartwatch, a desktop computer, etc. The computing device components described below may be suitable for the computing devices described above, including one or more devices associated with access point 102, wireless networks 104, as well as computing device(s) 112 discussed above with respect to FIG. 1. In some embodiments, computing device 112 may include at least one processor 114 and memory 130. Depending on the configuration and type of computing device, memory 130 may comprise, but is not limited to, volatile storage (e.g., random access memory), non-volatile storage (e.g., read-only memory), flash memory, removable storage, or any combination of such memories. Memory 130 may store instructions 160 that cause execution of an operating system 505 and one or more program modules 116-120 suitable for running a software application, such as one or more components supported by the systems described herein.

Data/information generated or captured and stored via computing device 112 may be stored locally, or the data may be stored on any number of storage media that may be accessed by computing device 112. For example, multiple computing devices 112 may be associated with a user (e.g., a laptop computer, a smartphone, and a smartwatch), which may share data stored on any of these devices. Similarly, such data/information may be readily transferred between computing devices for storage and use according to any of a variety of data/information transfer and storage means, including collaborative data/information sharing systems.

Embodiments of computing device 112 may include an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Computing device 112 may have one or more input device(s) 512 such as a keyboard, a mouse, a pen, a sound or voice input device, a touch or swipe input device, etc. Output device(s) 514 such as a display, speakers, a printer, etc. may also be included. Output devices 514 may include a display for showing a graphical user interface (GUI), a visual indicator (e.g., a light emitting diode), and/or an audio transducer (e.g., a speaker). In some embodiments, a vibration transducer is included for providing the user with tactile feedback. In some embodiments, input and/or output ports are included, such as an audio input (e.g., a microphone jack), an audio output (e.g., a headphone jack), and a video output (e.g., a HDMI port) for sending signals to or receiving signals from an external device. The aforementioned devices are examples and others may be used. Computing device 112 may include one or more communication connections 516 which facilitate communications with access point 102 (FIG. 1), wireless network 104, network 150 (e.g., the internet), other computing devices, or other devices. Examples of suitable communication connections 516 include, but are not limited to, radio frequency (RF) transmitter, receiver, and/or transceiver circuitry; universal serial bus (USB), parallel, and/or serial ports, etc.

In some embodiments, computing device 112 is configured for running one or more applications (e.g., browser, e-mail, calendaring, contact managers, messaging clients, games, and media clients/players). One or more application programs may be loaded into memory 130 and run on or in association with the operating system 505. Examples of the application programs include phone dialer programs, e-mail programs, personal information management (PIM) programs, word processing programs, spreadsheet programs, Internet browser programs, messaging programs, etc. The application programs may use and store information in memory 130, such as e-mail or other messages used by an e-mail application, and the like. As should be appreciated, other applications may be loaded into the memory and run on the computing device 112.

Computing device 112 may have a power supply 570, which may be implemented as one or more batteries, and/or other components that all computing device 112 to function as described herein. Power supply 570 may include an external power source, such as an AC adapter or a powered docking cradle that supplements or recharges the batteries.

It will be appreciated that computing device 112 may have additional features or functionality. Embodiments of the techniques described herein may be implemented using a single instance of computing device 112 or multiple computer systems configured to host different portions or instances of embodiments. Multiple computer systems may provide for parallel or sequential processing/execution of one or more portions of the techniques described herein.

While various items are illustrated as being stored in memory, these items or portions of them may be transferred between memory and other storage devices for purposes of memory management and data integrity. Alternatively, in other embodiments some or all of the software components execute in memory on another device and communicates with the illustrated computer system(s) via inter-computer communication. In some embodiments, some or all of the system components or data structures are stored (e.g., as instructions or structured data) on a computer-accessible medium or a portable article to be read by an appropriate drive, various examples of which are described above. In some embodiments, instructions stored on a computer-accessible medium separate from computing device 112 are transmitted to computing device 112 via transmission media or signals such as electrical, electromagnetic, or digital signals, conveyed via a communication medium such as a network or a wireless link. Various embodiments include receiving, sending, or storing instructions or data implemented in accordance with the foregoing description upon a computer-accessible medium. Accordingly, the present techniques may be practiced with other computer system configurations.

To mitigate the problems described herein, the inventors had to both invent solutions and, in some cases just as importantly, recognize problems overlooked (or not yet foreseen) by others for load balancing and distributing issue requests for resolution by assignable resources. The inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described.

In block diagrams, illustrated components are depicted as discrete functional blocks, but embodiments are not limited to systems in which the functionality described herein is organized as illustrated. The functionality provided by the components may be provided by software or hardware modules that are differently organized than is presently depicted, for example such software or hardware may be intermingled, conjoined, replicated, broken up, distributed (e.g., within a data center or geographically), or otherwise differently organized. The functionality described may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with individual computing devices having different subsets of the instructions, an implementation consistent with usage of the singular term “medium.” In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several embodiments. Rather than separating those embodiments into multiple isolated patent applications, applicants have grouped these embodiments into a single document because their related subject matter lends itself to economies in the application process. But the distinct advantages and aspects of these embodiments should not be conflated. In some cases, embodiments address all of the deficiencies noted herein, but it should be understood that the embodiments are independently useful, and some embodiments address only a subset of such problems or offer other, unmentioned benefits that will be apparent to those of skill in the art reviewing the present disclosure. Due to cost constraints, some disclosed embodiments are not presently claimed and may be claimed in later filings, such as continuation applications or by amending the present claims. Similarly, due to space constraints, neither the Abstract nor the Summary sections of the present document should be taken as containing a comprehensive listing of all such embodiments or all aspects of such embodiments.

It should be understood that the description and the drawings are not intended to limit an embodiment to the particular form disclosed, but to the contrary, the intention is to cover all modifications, equivalents, and alternatives falling within the spirit and scope of the present embodiments as defined by the appended claims. Further modifications and alternative embodiments will be apparent to those skilled in the art in view of this description. Accordingly, this description and the drawings are to be construed as illustrative only and are for the purpose of teaching those skilled in the art the general manner of carrying out the embodiments. It is to be understood that the forms of the embodiments shown and described herein are to be taken as examples of embodiments. Elements and materials may be substituted for those illustrated and described herein, parts and processes may be reversed or omitted, and certain features may be utilized independently, all as would be apparent to one skilled in the art after having the benefit of this description. Changes may be made in the elements described without departing from the spirit and scope of the embodiments as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include,” “including,” and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., all processors performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in a category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The present techniques will be better understood with reference to the following enumerated embodiments:

1. A method for securely accessing a wireless network, the method comprising: determining, with a computing device, one or more attributes of an access point to a wireless network, the one or more attributes providing context associated with the access point; comparing, with the computing device, the one or more attributes of the access point to a stored profile associated with the access point and the computing device, the stored profile comprising previous values for the one or more attributes, where comparing ensures the context associated with the access point is consistent with the stored profile for the access point and the computing device; and responsive to the attributes of the access point being consistent with the stored profile for the access point, establishing, with the computing device, a connection to the wireless network using the access point.

2. The method of embodiment 1, wherein the attributes comprise default attributes, and extended attributes.

3. The method of any of the previous embodiments, wherein the default attributes comprise one or more of identifiers, authentication modalities, and communication specifications of the access point; including one or more of a service set identifier (SSID) or network name, a basic service set identifier (BSSID), an authentication mode, a frequency band, a channel width, a data transfer rate including one or both of a transmit rate or a receive rate, one or more characteristics of a processor utilized by the access point, an encryption protocol, one or more access point firmware characteristics, and one or more access point software characteristics.

4. The method of any of the previous embodiments, wherein the extended attributes comprise one or more of a number of hops between the computing device and the access point, a geographical access point location, a triangulated position of the access point, a physical distance from the computing device to the access point, a re-authentication interval; computing device security protocol transition; uppercase media access control authentication; and a received signal strength indicator (RSSI).

5. The method of any of the previous embodiments, wherein at least some of the one or more attributes are determined based on others of the one or more attributes.

6. The method of any of the previous embodiments, wherein the access point comprises one or more of a router, a wireless network adapter, a hotspot, or a Wi-Fi chipset.

7. The method of any of the previous embodiments, wherein the stored profile comprises a stored profile for an alternate access point that is associated with the access point being compared, whether through geographical location, the provider of the wireless connection, or any other form of association.

8. The method of any of the previous embodiments, wherein the stored profile is shared between the computing device and one or more other computing devices belonging to a user.

9. The method of any of the previous embodiments, wherein the stored profile is stored on one or more computing devices belonging to a user.

10. The method of any of the previous embodiments, further comprising, responsive to the one or more attributes being consistent with the stored profile, updating the stored profile with the computing device, based on the one or more attributes.

11. The method of any of the previous embodiments, further comprising iteratively updating the stored profile each time the computing device attempts to connect to the wireless network using the access point, responsive to the one or more attributes being consistent with the stored profile for that connection attempt.

12. The method of any of the previous embodiments, wherein the stored profile for the access point comprises an aggregate historical set of attributes for the access point, and wherein the previous values are determined based on the aggregate historical set of attributes.

13. The method of any of the previous embodiments, wherein the previous values for one or more of the attributes comprise an aggregate value associated with a combination of at least two of the attributes.

14. The method of any of the previous embodiments, wherein the previous values for one or more of the attributes comprise one or more per attribute values associated with individual attributes.

15. The method of any of the previous embodiments, wherein the determining, comparing, and establishing is configured to prevent connection to a fraudulent wireless network.

16. The method of any of the previous embodiments, further comprising, responsive to the one or more attributes of the access point not being consistent with the stored profile, not establishing the connection to the wireless network using the access point, and instead outputting, with the computing device, an indication that the access point might be fraudulent.

17. The method of any of the previous embodiments, further comprising requiring a user intervention, for verification and re-connecting to the access point, to safely connect with the wireless network to ensure that the computing device is connecting to an authentic endpoint, and not a fraudulent wireless network.

18. The method of any of the previous embodiments, wherein the computing device comprises a smartphone, laptop computer, or other user-associated devices such as smart watches, fitness trackers, and smart home devices.

19. The method of any of the previous embodiments, wherein the determining, comparing, and establishing are performed by the computing device, independent of access point hardware or access point configurations that are provided by the access point.

20. The method of any of the previous embodiments, further comprising performing the determining, comparing, and establishing with the computing device each time the computing device attempts to connect to the wireless network using the access point.

21. A computing device configured to securely access a wireless network, the computing device comprising a smartphone or a laptop computer associated with a user, the computing device comprising: a processor; and memory storing instructions that, when executed by the processor, cause the computing device to: determine one or more attributes of an access point to a wireless network, the access point comprising one or more of a router, a wireless network adapter, a hotspot, or a Wi-Fi chipset; the one or more attributes providing context associated with the access point; compare the one or more attributes of the access point to a stored profile associated with the access point and the computing device, the stored profile comprising one previous values for the one or more attributes, the comparing ensuring the context associated with the access point is consistent with the stored profile for the access point and the computing device; responsive to the attributes of the access point being consistent with the stored profile for the access point: establish, with the computing device, a connection to the wireless network using the access point; and update the stored profile with the computing device, based on the one or more attributes; or responsive to the one or more attributes of the access point not being consistent with the stored profile: not establish the connection to the wireless network using the access point, and instead output, with the computing device, an indication that the access point might be fraudulent; and require a user intervention, for verification and re-connecting to the access point, to safely connect with the wireless network to ensure that the computing device is connecting to an authentic endpoint, and not a fraudulent wireless network; and perform the determining, comparing, and establishing or not establishing with the computing device each time the computing device attempts to connect to the wireless network using the access point.

22. The device of embodiment 21, wherein the attributes comprise default attributes, and extended attributes.

23. The device of any of the previous embodiments, wherein the default attributes comprise one or more of identifiers, authentication modalities, and communication specifications of the access point; including one or more of a service set identifier (SSID) or network name, a basic service set identifier (BSSID), an authentication mode, a frequency band, a channel width, a data transfer rate including one or both of a transmit rate or a receive rate, one or more characteristics of a processor utilized by the access point, an encryption protocol, one or more access point firmware characteristics, and one or more access point software characteristics.

24. The device of any of the previous embodiments, wherein the extended attributes comprise one or more of a number of hops between the computing device and the access point, a geographical access point location, a triangulated position of the access point, a physical distance from the computing device to the access point, a re-authentication interval; computing device security protocol transition; uppercase media access control authentication; and a received signal strength indicator (RSSI).

25. The device of any of the previous embodiments, wherein at least some of the one or more attributes are determined based on others of the one or more attributes.

26. The device of any of the previous embodiments, wherein the stored profile for the access point comprises an aggregate historical set of attributes for the access point, and wherein the previous values are determined based on the aggregate historical set of attributes.

27. The device of any of the previous embodiments, wherein the previous values for one or more of the attributes comprise an aggregate value associated with a combination of at least two of the attributes.

28. The device of any of the previous embodiments, wherein the previous values for one or more of the attributes comprise one or more per attribute values associated with individual attributes.

29. The device of any of the previous embodiments, wherein the determining, comparing, and establishing is configured to prevent connection to a fraudulent wireless network.

30. The device of any of the previous embodiments, wherein the determining, comparing, and establishing are performed by the computing device, beyond the use of configurations provided by the access point, and independently of access point hardware or access point configurations.

31. A non-transitory computer readable medium having instructions thereon, the instructions, when executed by a computing device from a set of one or more computing devices associated with a user, causing the computing device to perform operations for securely accessing a wireless network, the operations comprising: determining one or more attributes of an access point to a wireless network, the one or more attributes providing context associated with the access point; and comparing the one or more attributes of the access point to a stored profile associated with the access point and the computing device and/or one or more of the computing devices in the set, the stored profile shared between the one or more computing devices in the set, the stored profile comprising previous values for the one or more attributes, the comparing ensures the context associated with the access point is consistent with the stored profile for the access point and the one or more computing devices.

32. The medium of embodiment 31, the operations further comprising, responsive to the attributes of the access point being consistent with the stored profile for the access point, establishing, with the computing device, a connection to the wireless network using the access point.

33. The medium of any of the previous embodiments, wherein the attributes comprise default attributes, and extended attributes.

34. The medium of any of the previous embodiments, wherein the default attributes comprise one or more of identifiers, authentication modalities, and communication specifications of the access point; including one or more of a service set identifier (SSID) or network name, a basic service set identifier (BSSID), an authentication mode, a frequency band, a channel width, a data transfer rate including one or both of a transmit rate or a receive rate, one or more characteristics of a processor utilized by the access point, an encryption protocol, one or more access point firmware characteristics, and one or more access point software characteristics.

35. The medium of any of the previous embodiments, wherein the extended attributes comprise one or more of a number of hops between the computing device and the access point, a geographical access point location, a triangulated position of the access point, a physical distance from the computing device to the access point, a re-authentication interval; computing device security protocol transition; uppercase media access control authentication; and a received signal strength indicator (RSSI).

36. The medium of any of the previous embodiments, wherein at least some of the one or more attributes are determined based on others of the one or more attributes.

37. The medium of any of the previous embodiments, wherein the access point comprises one or more of a router, a wireless network adapter, a hotspot, or a Wi-Fi chipset.

38. The medium of any of the previous embodiments, wherein the stored profile comprises a stored profile for an alternate access point that is associated with the access point being compared, whether through geographical location, the provider of the wireless connection, or any other form of association.

39. The medium of any of the previous embodiments, wherein the stored profile is stored on one or more of the computing device and one or more of the computing devices in the set associated with a user.

40. The medium of any of the previous embodiments, the operations further comprising, responsive to the one or more attributes being consistent with the stored profile, updating the stored profile with the computing device, based on the one or more attributes.

41. The medium of any of the previous embodiments, the operations further comprising iteratively updating the stored profile each time the computing device attempts to connect to the wireless network using the access point, responsive to the one or more attributes being consistent with the stored profile for that connection attempt.

42. The medium of any of the previous embodiments, wherein the stored profile for the access point comprises an aggregate historical set of attributes for the access point, and wherein the previous values are determined based on the aggregate historical set of attributes.

43. The medium of any of the previous embodiments, wherein the previous values for one or more of the attributes comprise an aggregate value associated with a combination of at least two of the attributes.

44. The medium of any of the previous embodiments, wherein the previous values for one or more of the attributes comprise one or more per attribute values associated with individual attributes.

45. The medium of any of the previous embodiments, wherein the determining, comparing, and establishing is configured to prevent connection to a fraudulent wireless network.

46. The medium of any of the previous embodiments, the operations further comprising, responsive to the one or more attributes of the access point not being consistent with the stored profile, not establishing a connection to the wireless network using the access point, and instead outputting, with the computing device, an indication that the access point might be fraudulent.

47. The medium of any of the previous embodiments, the operations further comprising requiring a user intervention, for verification and re-connecting to the access point, to safely connect with the wireless network to ensure that the computing device is connecting to an authentic endpoint, and not a fraudulent wireless network.

48. The medium of any of the previous embodiments, wherein the computing device and the set of one or more computing devices comprise one or more of a smartphone, laptop computer or other user-associated devices such as smart watches, fitness trackers, and smart home devices.

49. The medium of any of the previous embodiments, wherein the determining, comparing, and establishing are performed by the computing device, beyond the use of configurations provided by the access point, and independently of access point hardware or access point configurations.

50. The medium of any of the previous embodiments, the operations further comprising performing the determining, comparing, and establishing with the computing device each time the computing device attempts to connect to the wireless network using the access point.

1. A method for securely accessing a wireless network, the method comprising:
determining, with a computing device, one or more attributes of an access point to a wireless network, the one or more attributes providing context associated with the access point;
comparing, with the computing device, the one or more attributes of the access point to a stored profile associated with the access point and the computing device, the stored profile comprising previous values for the one or more attributes, where comparing ensures the context associated with the access point is consistent with the stored profile for the access point and the computing device; and
responsive to the attributes of the access point being consistent with the stored profile for the access point, establishing, with the computing device, a connection to the wireless network using the access point.

2. The method of claim 1, wherein the attributes comprise default attributes, and extended attributes.

3. The method of claim 2, wherein the default attributes comprise one or more of identifiers, authentication modalities, and communication specifications of the access point; including one or more of a service set identifier (SSID) or network name, a basic service set identifier (BSSID), an authentication mode, a frequency band, a channel width, a data transfer rate including one or both of a transmit rate or a receive rate, one or more characteristics of a processor utilized by the access point, an encryption protocol, one or more access point firmware characteristics, and one or more access point software characteristics.

4. The method of claim 2, wherein the extended attributes comprise one or more of a number of hops between the computing device and the access point, a geographical access point location, a triangulated position of the access point, a physical distance from the computing device to the access point, a re-authentication interval; computing device security protocol transition; uppercase media access control authentication; and a received signal strength indicator (RSSI).

5. The method of claim 1, wherein at least some of the one or more attributes are determined based on others of the one or more attributes.

6. The method of claim 1, wherein the stored profile comprises a stored profile for an alternate access point that is associated with the access point being compared, whether through geographical location, or the provider of the wireless connection.

7. The method of claim 1, wherein the stored profile is shared between the computing device and one or more other computing devices belonging to a user.

8. The method of claim 1, wherein the stored profile is stored on one or more computing devices belonging to a user.

9. The method of claim 1, further comprising, responsive to the one or more attributes being consistent with the stored profile, updating the stored profile with the computing device, based on the one or more attributes.

10. The method of claim 9, further comprising iteratively updating the stored profile each time the computing device attempts to connect to the wireless network using the access point, responsive to the one or more attributes being consistent with the stored profile for that connection attempt.

11. The method of claim 1, wherein the stored profile for the access point comprises an aggregate historical set of attributes for the access point, and wherein the previous values are determined based on the aggregate historical set of attributes.

12. The method of claim 1, wherein the previous values for one or more of the attributes comprise an aggregate value associated with a combination of at least two of the attributes.

13. The method of claim 1, wherein the previous values for one or more of the attributes comprise one or more per attribute values associated with individual attributes.

14. The method of claim 1, further comprising, responsive to the one or more attributes of the access point not being consistent with the stored profile, not establishing the connection to the wireless network using the access point, and instead outputting, with the computing device, an indication that the access point might be fraudulent.

15. The method of claim 14, further comprising requiring a user intervention, for verification and re-connecting to the access point, to safely connect with the wireless network to ensure that the computing device is connecting to an authentic endpoint, and not a fraudulent wireless network.

16. A computing device configured to securely access a wireless network, the computing device comprising a smartphone, laptop computer or other user-associated devices including smart watches, fitness trackers, and smart home devices, the computing device comprising:
a processor; and
memory storing instructions that, when executed by the processor, cause the computing device to:
determine one or more attributes of an access point to a wireless network, the access point comprising one or more of a router, a wireless network adapter, a hotspot, or a Wi-Fi chipset; the one or more attributes providing context associated with the access point;
compare the one or more attributes of the access point to a stored profile associated with the access point and the computing device, the stored profile comprising previous values for the one or more attributes, where comparing ensures the context associated with the access point is consistent with the stored profile for the access point and the computing device;
responsive to the attributes of the access point being consistent with the stored profile for the access point:
establish, with the computing device, a connection to the wireless network using the access point; and update the stored profile with the computing device, based on the one or more attributes; or
responsive to the one or more attributes of the access point not being consistent with the stored profile:
not establish the connection to the wireless network using the access point, and instead output, with the computing device, an indication that the access point might be fraudulent; and require a user intervention, for verification and re-connecting to the access point, to safely connect with the wireless network to ensure that the computing device is connecting to an authentic endpoint, and not a fraudulent wireless network; and
perform the determining, comparing, and establishing or not establishing with the computing device each time the computing device attempts to connect to the wireless network using the access point.

17. A non-transitory computer readable medium having instructions thereon, the instructions, when executed by a computing device from a set of one or more computing devices associated with a user, causing the computing device to perform operations for securely accessing a wireless network, the operations comprising:
determining one or more attributes of an access point to a wireless network, the one or more attributes providing context associated with the access point; and
comparing the one or more attributes of the access point to a stored profile associated with the access point and the computing device and/or one or more of the computing devices in the set, the stored profile shared between the one or more computing devices in the set, the stored profile comprising previous values for the one or more attributes, where comparing ensures the context associated with the access point is consistent with the stored profile for the access point and the one or more computing devices.

18. The medium of claim 17, the operations further comprising, responsive to the attributes of the access point being consistent with the stored profile for the access point, establishing, with the computing device, a connection to the wireless network using the access point.

19. The medium of claim 17, wherein the attributes comprise default attributes, and extended attributes,
wherein the default attributes comprise one or more of identifiers, authentication modalities, and communication specifications of the access point; including one or more of a service set identifier (SSID) or network name, a basic service set identifier (BSSID), an authentication mode, a frequency band, a channel width, a data transfer rate including one or both of a transmit rate or a receive rate, one or more characteristics of a processor utilized by the access point, an encryption protocol, one or more access point firmware characteristics, and one or more access point software characteristics; and
wherein the extended attributes comprise one or more of a number of hops between the computing device and the access point, a geographical access point location, a triangulated position of the access point, a physical distance from the computing device to the access point, a re-authentication interval; computing device security protocol transition; uppercase media access control authentication; and a received signal strength indicator (RSSI).

20. The medium of claim 17, the operations further comprising, responsive to the one or more attributes being consistent with the stored profile,
updating the stored profile with the computing device, based on the one or more attributes; and
iteratively updating the stored profile each time the computing device attempts to connect to the wireless network using the access point, responsive to the one or more attributes being consistent with the stored profile for that connection attempt.
